(19) United States
(12) Patent Application Publication
(10) Pub. No.: US 2022/0074090 A1
(43) Pub. Date: Mar. 10, 2022

(54) BREATHABLE BAFFLES

(71) Applicant: The North Face Apparel Corp., Wilmington, DE (US)

(72) Inventors: Cory Michael Olson, Golden, CO (US); Bonny Violet Allison, Denver, CO (US); Jeffrey Allen Dorton, Dublin, CA (US)

(21) Appl. No.: 17/467,068

(22) Filed: Sep. 3, 2021

Related U.S. Application Data
(60) Provisional application No. 63/075,024, filed on Sep. 4, 2020.

(51) Int. Cl. D04B 1/04; A41D 31/06; A41D 31/14

(52) U.S. Cl. CPC D04B 1/04; A41D 31/102; A41D 31/145; A41D 31/065

(57) ABSTRACT

A composite material for an insulation baffle comprising a baffle layer comprising a plurality of baffle shell structures coupled to one another by spacers, wherein each of the baffle shell structures comprises a baffle face layer and a baffle back layer that define a cavity therebetween, and wherein the spacers define a breathablity zone having a higher air permeability than one or more of the baffle face layer and a baffle back layer measured in accordance with ASTM D737.

### CROSS REFERENCE TO RELATED APPLICATIONS

This application claims priority to and the benefit of U.S. Ser. No. 63/075,024 filed Sep. 4, 2020, which is expressly incorporated by reference herein in its entirety.

### BACKGROUND

Some items, such as snow pants, footwear, tents, etc., may be useful for keeping users comfortable. Keeping users comfortable may comprise keeping users dry from rain, hail, snow, etc. Making items out of material that is sufficiently water-resistant may keep users dry. Keeping users comfortable may comprise allowing hot air to escape so that users may remain cool. Making items out of material that is sufficiently breathable may allow hot air to escape. Improvements are needed.

### SUMMARY

Composite materials are described herein. An example composite material may comprise: a baffle layer comprising a plurality of baffle structures coupled to one another by spacers, wherein each of the baffle structures comprises an upper layer and a lower layer that define a cavity therebetween; a lamination layer disposed on the upper layer of one or more of the baffle structures (or baffles); and a face layer disposed on or adjacent the upper layer such that the lamination layer is interposed between the face layer and the baffle layer.

A composite material for an insulation baffle comprising a baffle layer comprising a plurality of baffle shell structures coupled to one another by spacers, wherein each of the baffle shell structures comprises a baffle face layer and a baffle back layer that define a cavity therebetween, and wherein the spacers define a breathablity zone having a higher air permeability than one or more of the baffle face layer and the baffle back layer measured in accordance with ASTM D737.

A composite material for an insulation baffle, the composite material comprising: a baffle layer comprising a plurality of baffle shell structures coupled to one another by spacers, wherein each of the baffle shell structures comprises a baffle face layer and a baffle back layer that define a cavity therebetween, and wherein the spacers define a breathablity zone having a higher air permeability than one or more of the baffle face layer and a baffle back layer measured in accordance with ASTM D737; and a cover layer disposed on or adjacent the baffle back layer.

An example composite material may comprise a shell fiber layer. The example composite material may comprise a membrane disposed adjacent the shell fiber layer. The example composite material may exhibit a low range hydrostatic water resistance of above 5000 millimeters (mm) as measured using American Association of Textile Chemists and Colorists (AATCC) 127. The example composite material may exhibit an air permeability of above 0.25 cubic feet per minute (cfm) as measured using American Society for Testing and Materials (ASTM) D737. The example composite material may exhibit a moisture vapor transmission rate (MVTR) of above 30 kilograms per square meter per 24 hour (kg/sqm/24 hr) as measured using Japanese Industry Standards (JIS) L1099-B1.

Composite materials are described herein. An example composite material may comprise a shell fiber layer. The example composite material may comprise a membrane disposed adjacent the shell fiber layer. The example composite material may exhibit a low range hydrostatic water resistance of between 5000 millimeters (mm) and 25,000 mm as measured using American Association of Textile Chemists and Colorists (AATCC) 127. The example composite material may exhibit an air permeability of between 0.25 and 1 cubic feet per minute (cfm) as measured using American Society for Testing and Materials (ASTM) D737. The example composite material may exhibit a moisture vapor transmission rate (MVTR) of between 30 kilograms per square meter per 24 hour (kg/sqm/24 hr) and 60 Kg/sqm/24 hr as measured using Japanese Industry Standards (JIS) L1099-B1.

Composite materials are described herein. An example composite material may comprise a shell fiber layer. The example composite material may comprise a membrane disposed adjacent the shell fiber layer. The example composite material may exhibit a low range hydrostatic water resistance of between 5000 millimeters (mm) and 25,000 mm as measured using American Association of Textile Chemists and Colorists (AATCC) 127. The example composite material may exhibit an air permeability of between 0.25 and 1 cubic feet per minute (cfm) as measured using American Society for Testing and Materials (ASTM) D737. The example composite material may exhibit a moisture vapor transmission rate (MVTR) of between 30 kilograms per square meter per 24 hour (kg/sqm/24 hr) and 55 Kg/sqm/24 hr as measured using Japanese Industry Standards (JIS) L1099-B1.

Composite materials are described herein. An example composite material may comprise a shell fiber layer. The example composite material may comprise a membrane disposed adjacent the shell fiber layer. The example composite material may exhibit a low range hydrostatic water resistance of between 5000 millimeters (mm) and 25,000 mm as measured using American Association of Textile Chemists and Colorists (AATCC) 127. The example composite material may exhibit an air permeability of between 0.75 and 1 cubic feet per minute (cfm) as measured using American Society for Testing and Materials (ASTM) D737.

Down-proof baffles are described herein. An example down-proof baffle may comprise composite material. The example composite material may comprise a membrane disposed adjacent a face layer and a backer layer adjacent the membrane opposite the face layer. The example composite material may exhibit a low range hydrostatic water resistance of between 0 millimeters (mm) and 16,000 mm as measured using American Association of Textile Chemists and Colorists (AATCC) 127. The example composite material may exhibit an air permeability of between 0.1 and 1.5 cubic feet per minute (cfm) as measured using American Society for Testing and Materials (ASTM) D737. The example composite material may exhibit a moisture vapor transmission rate (MVTR) of between 2 kilograms per square meter per 24 hour (kg/sqm/24 hr) and 65 Kg/sqm/24 hr as measured using Japanese Industry Standards (JIS) L1099-B1.

Down-proof baffles are described herein. An example down-proof baffle may comprise composite material. The example composite material may comprise a membrane disposed adjacent a face layer and a backer layer adjacent the membrane opposite the face layer. The example composite material may exhibit a low range hydrostatic water resistance of between 2000 millimeters (mm) and 15,000 mm as measured using American Association of Textile Chemists and Colorists (AATCC) 127. The example composite material may exhibit an air permeability of between 0.1 and 1.0 cubic feet per minute (cfm) as measured using American Society for Testing and Materials (ASTM) D737. The example composite material may exhibit a moisture vapor transmission rate (MVTR) of between 1 kilogram per square meter per 24 hour (kg/sqm/24 hr) and 65 Kg/sqm/24 hr as measured using Japanese Industry Standards (JIS) L1099-B1.

Down-proof baffles are described herein. An example down-proof baffle may comprise composite material. The example composite material may comprise a membrane disposed adjacent a face layer and a backer layer adjacent the membrane opposite the face layer. The example composite material may exhibit a low range hydrostatic water resistance greater than 9000 millimeters (mm) as measured using American Association of Textile Chemists and Colorists (AATCC) 127. The example composite material may exhibit an air permeability greater than 0.2 cubic feet per minute (cfm) as measured using American Society for Testing and Materials (ASTM) D737. The example composite material may exhibit a moisture vapor transmission rate (MVTR) greater than 8 kilograms per square meter per 24 hour (kg/sqm/24 hr) as measured using Japanese Industry Standards (JIS) L1099-B1.

Articles are described herein. An example article may comprise down-proof baffles described herein. An example down-proof baffle may comprise composite material described herein. The example article may comprise a garment, gloves, footwear, headwear, bib pants, pants, a jacket, a tent, a sleeping bag, a blanket and a backpack. Other articles may be used.

### BRIEF DESCRIPTION OF THE DRAWINGS

The following drawings show generally, by way of example, but not by way of limitation, various examples discussed in the present disclosure. In the drawings:

FIG. 1 is a perspective representation of an article comprising a layered composite in accordance with the present disclosure.

FIG. 2 illustrates a perspective representation of an insulative baffle in accordance with the present disclosure.

### DETAILED DESCRIPTION

Composite materials are described herein. The composite materials may be or comprise laminate materials having a plurality of layers. An example composite material may comprise a shell and a membrane. The shell may comprise a shell fiber layer. The shell may comprise various materials such as polymers. The shell may comprise polyester, nylon, recycled polyester, elastane, or combinations thereof. Other materials may be used. The membrane may be or comprise a breathable membrane. The membrane may be or comprise a waterproof or water repellant membrane. The membrane may be formed from various process such as fiber spinning (e.g., electrospinning). Together, the shell and membrane may have a fabric weight. Various combinations of shell and membrane weight may be used. The membrane may have a weight of less than 9 gsm, less than 8 gsm, less than 7 gsm, less than 6 gsm, less than 5 gsm, less than 4 gsm, or less than 3 gsm. Other weight membranes may be used. The shell and the membrane may be disposed adjacent each other and may be coupled together, for example using adhesive.

Down-proof baffles are described herein. An example down-proof baffle may be configured to hold an insulative material or structure. The example down-proof baffle may comprise composite material and a membrane. The composite material may be or comprise the shell of the down-proof baffle. The composite material may be or comprise laminate materials having a plurality of layers. The layers may comprise nylon, polyester, elastane, cotton, wool, polypropylene, polyethylene or combinations thereof. The layers may comprise dissolvable yarns for enhanced or engineered breathability. Other materials may be used. The membrane may be or comprise a water proof or water repellant membrane. The membrane may be formed from various process such as fiber spinning (e.g., electrospinning).

An example composite material for a down-proof baffle may comprise a membrane and one or more layers disposed adjacent the membrane. The example composite material may comprise a membrane disposed adjacent a face layer. The example composite material may comprise a backer layer disposed adjacent the membrane opposite the face layer. The backer layer may be down-proof. Additional layers may be included. The membrane and the layers may be coupled together, for example with glue or adhesive. Together, the layers and the membrane may have a fabric weight. Various combinations of membrane and layers may be used. The membrane may have a weight of less than 9 gsm, less than 8 gsm, less than 7 gsm, less than 6 gsm, less than 5 gsm, less than 4 gsm, or less than 3 gsm. Other weight membranes may be used.

The composites of the present disclosure show improved performance over comparative conventional materials. As shown more clearly in Tables 1-3, the composite materials of the present disclosure are identified using ID's: LV6W, LV6Z, LV74, LWEN, LV71, LWEQ, LV75, LWEP, LV7B, LVID, and LWEO. The comparative examples are identified as A-L. The Appendix, which is hereby incorporate herein by reference in its entirety shows improved performance of the composite materials after 20 launderings.

Table 1 matches “High”, “Medium”, and “Low” labels
for example value ranges for various measurements:

| | Low Range | | Air | | | |
|---|---|---|---|---|---|---|
| | Hydrostatic (AATCC | | Permeability (ASTM | | MVTR (JIS | |
| KEY | 127) - As Received | | D737) - As Received | | L1099-B1) | |
| High | 10,000 | mm+ | .75 | cfm+ | 45K | g/sqm/24hr+ |
| Medium | 5,000-10,000 | mm | .25-.75 | cfm | 30K-45K | g/sqm/24hr |
| Low | 0-5,000 | mm | 0-0.25 | cfm | 0-30K | g/sqm/24hr |

Table 2 shows attributes of various jackets:

| ID | Shell Fiber Content | Fabric Weight | |
|---|---|---|---|
| A | 72% Polyester, | 132 | gsm |
| | 28% Nylon | | |
| B | 100% Nylon | 82 | gsm |
| C | 100% Nylon | 182 | gsm |
| D | 100% Nylon with | 84 | gsm |
| | 100% Polyester Backer | | |
| E | 100% Nylon | 83 | gsm |
| F | 100% Recycled Polyester | Body: 150 gsm; | |
| | | Hood: 153 gsm | |
| G | 100% Nylon | Body: 105 gsm; | |
| | | Hood: 115 gsm | |
| H | 100% Nylon | 161 | gsm |
| I | 100% Nylon | 120 | gsm |
| J | 100% Nylon | 54 | gsm |
| K | 100% Nylon | 64 | gsm |
| L | 100% Recycled Polyester | 114 | gsm |
| LV6W | 58% Nylon, | 102 | gsm |
| | 37% Polyester, | | |
| | 5% Elastane | | |
| LV6Z | 100% Polyester | 177 | gsm |
| LV74 | 100% Polyester | 173 | gsm |
| LWEN | 93% Nylon, | 160 | gsm |
| | 7% Elastane | | |
| LV71 | 100% Polyester | 91 | gsm |
| LWEQ | 93% Nylon, | 168 | gsm |
| | 7% Elastane | | |
| LV75 | 62% Nylon, | 136 | gsm |
| | 33% Polyester, | | |
| | 5% Elastane | | |
| LWEP | 93% Nylon, | 158 | gsm |
| | 7% Elastane | | |
| LV7B | 75% Polyester, | 163 | gsm |
| | 25% Nylon | | |
| LV7D | 75% Polyester, | 165 | gsm |
| | 25% Nylon | | |
| LWEO | 96% Nylon, | 164 | gsm |
| | 4% Elastane | | |

Table 3 matches labels shows in Table
1 with jackets identified in Table 2.

| | Low Range | Air | |
|---|---|---|---|
| | Hydrostatic (AATCC | Permeability (ASTM | MVTR (JIS |
| ID | 127) - As Received | D737) - As Received | L1099-B1) |
| A | High | Medium | Low |
| B | Low | Medium | High |
| C | High | Low | Low |
| D | Low | High | Medium |
| E | Medium | Low | Low |
| F | High | Low | Medium |
| G | High | Low | High |
| H | High | Low | Low |
| I | High | Low | Medium |
| J | Medium | Low | Medium |
| K | Low | Low | Low |
| L | High | Low | Low |
| LV6W | Medium | Medium | Medium |
| LV6Z | High | Medium | Medium |
| LV74 | High | Medium | Medium |
| LWEN | Medium | Medium | Low |
| LV71 | Medium | High | High |
| LWEQ | Medium | Medium | Medium |
| LV75 | Medium | Medium | Medium |
| LWEP | Medium | Medium | Low |
| LV7B | High | Medium | Medium |
| LV7D | Medium | Medium | Medium |
| LWEO | Medium | High | Low |

Composite materials are described herein. An example composite material may comprise a shell fiber layer. The shell fiber layer may comprise one or more of nylon, polyester, or elastane. The shell fiber layer may consist essentially of one or more of nylon, polyester, or elastane. The shell fiber layer may comprise about 100 weight percent (wt %) polyester from a total of 100 wt % of the shell fiber layer. The shell fiber layer may comprise greater than 90 wt % polyester from a total of 100 wt %. The shell fiber layer may comprise about 90 wt %, 91 wt %, 92 wt %, 93 wt %, 94 wt %, 95 wt %, 96 wt %, 97 wt %, 98 wt %, 99 wt %. Other loadings may be used. The shell fiber layer may comprise about 58 wt % nylon, about 37 wt % polyester, and about 5 wt % elastane. The shell fiber layer may comprise about 93 wt % nylon and about 7 wt % elastane. The shell fiber layer may comprise between 50 wt % and 100 wt % nylon. The shell fiber layer may comprise nylon by weight percent wt % as 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt % based on 100 wt % of the composite material. Other loadings may be used. The shell fiber layer may comprise about 62 wt % nylon, about 33 wt % polyester, and about 5 wt % elastane. The shell fiber layer may comprise about 93 wt % nylon and about 7 wt % elastane. The shell fiber layer may comprise about 75 wt % polyester and about 25 wt % nylon. The shell fiber layer may comprise 96% nylon and 4% elastane.

The example composite material may comprise a membrane disposed adjacent the shell fiber layer. The membrane may be coupled to the shell fiber layer. The membrane may be glued to the shell fiber layer.

Composite materials are described herein. An example composite material may comprise a shell fiber layer. The example composite material may comprise a membrane disposed adjacent the shell fiber layer. The example composite material may exhibit a low range hydrostatic water resistance of above 5000 millimeters (mm) as measured using American Association of Textile Chemists and Colorists (AATCC) 127. The example composite material may exhibit an air permeability of above 0.25 as measured using American Society for Testing and Materials (ASTM) D737. The example composite material may exhibit a moisture vapor transmission rate (MVTR) of above 30 kilograms per square meter per 24 hour (kg/sqm/24 hr) as measured using Japanese Industry Standards (JIS) L1099-B1.

The example composite material may exhibit a low range hydrostatic water resistance of between 5000 millimeters (mm) and 25,000 mm as measured using American Association of Textile Chemists and Colorists (AATCC) 127. The example composite material may exhibit an air permeability of between 0.25 and 1 cubic feet per minute (cfm) as measured using American Society for Testing and Materials (ASTM) D737. The example composite material may exhibit a moisture vapor transmission rate (MVTR) of between 30 kilograms per square meter per 24 hour (kg/sqm/24 hr) and 55 Kg/sqm/24 hr as measured using Japanese Industry Standards (JIS) L1099-B1.

A fabric weight associated with the example composite material may be between 90 grams per square meter (gsm) and 200 gsm. A fabric weight associated with the example composite material may be between 90 gsm and 180 gsm. A fabric weight associated with the example composite material may be between 91 gsm and 177 gsm. Other fabric weights and component weights may be used.

The example composite material may exhibit a low range hydrostatic water resistance of between 5000 millimeters (mm) and 25,000 mm as measured using American Association of Textile Chemists and Colorists (AATCC) 127. The example composite material may exhibit an air permeability of between 0.75 and 1 cubic feet per minute (cfm) as measured using American Society for Testing and Materials (ASTM) D737.

A fabric weight associated with the example composite material may be between 90 grams per square meter (gsm) and 200 gsm. A fabric weight associated with the example composite material may be between 90 gsm and 180 gsm. A fabric weight associated with the example composite material may be between 91 gsm and 177 gsm.

The example composite material for a down-proof baffle may exhibit a low range hydrostatic water resistance of between 0 millimeters (mm) and 16,000 mm as measured using American Association of Textile Chemists and Colorists (AATCC) 127. The example composite material may exhibit an air permeability of between 0.1 and 1.5 cubic feet per minute (cfm) as measured using American Society for Testing and Materials (ASTM) D737. The example composite material may exhibit a moisture vapor transmission rate (MVTR) of between 2 kilograms per square meter per 24 hour (kg/sqm/24 hr) and 65 Kg/sqm/24 hr as measured using Japanese Industry Standards (JIS) L1099-B1.

The example composite material for a down-proof baffle may exhibit a low range hydrostatic water resistance of between 2000 millimeters (mm) and 15,000 mm as measured using American Association of Textile Chemists and Colorists (AATCC) 127. The example composite material may exhibit an air permeability of between 0.1 and 1.0 cubic feet per minute (cfm) as measured using American Society for Testing and Materials (ASTM) D737. The example composite material may exhibit a moisture vapor transmission rate (MVTR) of between 1 kilogram per square meter per 24 hour (kg/sqm/24 hr) and 65 Kg/sqm/24 hr as measured using Japanese Industry Standards (JIS) L1099-B1.

The example composite material for a down-proof baffle may exhibit a low range hydrostatic water resistance greater than 9000 millimeters (mm) as measured using American Association of Textile Chemists and Colorists (AATCC) 127. The example composite material may exhibit an air permeability greater than 0.2 cubic feet per minute (cfm) as measured using American Society for Testing and Materials (ASTM) D737. The example composite material may exhibit a moisture vapor transmission rate (MVTR) greater than 8 kilograms per square meter per 24 hour (kg/sqm/24 hr) as measured using Japanese Industry Standards (JIS) L1099-B1.

Articles are described herein. An example article may comprise composite material described herein. The example article may comprise a garment, gloves, footwear, headwear, bib pants, pants, a jacket, a tent, a sleeping bag, blanket and a backpack. The example article may comprise a plurality of down-proof baffles described herein. The example down-proof baffles may be seam-sealed to provide a fully waterproof article. The example down-proof baffle may be configured to hold an insulative material or structure.

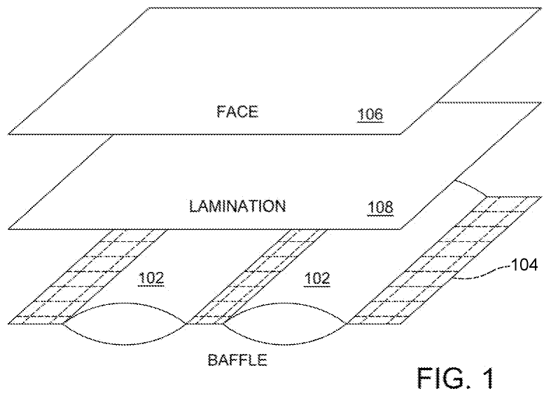

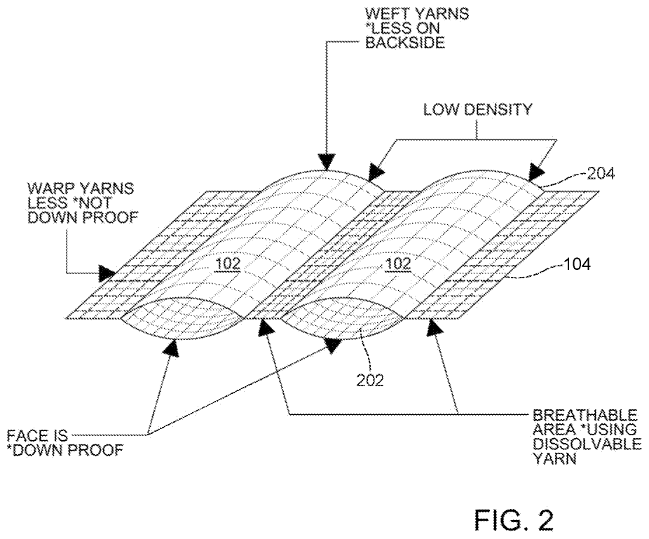

As an illustrative example, FIGS. 1-2 illustrate an article in accordance with the present disclosure. The article may be or comprise one or more baffles 102 for insulation. Insulation may comprise down, synthetics, or a combination of both. One or more of the baffles 102 may comprise a shell having opposing layers or surfaces configured to minimize escape of insulation therethrough. One or more spacers 104 (e.g., connectors, connection zones, etc.) may be disposed between the baffles 102. As an example, one or more of the spacers 104 may comprise a material or composite that couples adjacent ones of the baffles 102 to each other. It is noted that the baffles 102 and the spacers 104 may have different material properties. For example, the spacers 104 may be configured for breathability to create a breathability zone. Additionally or alternatively, the baffles may be configured to contain insulation and may be configured to be down proof to minimize escape of insulative materials. Configuring a material or surface to minimize escape of insulation may reduce the breathability. As an illustrative example, a “downproof” surface or composite material may have between 0.1 cfm and 3.0 cfm air permeability measured in accordance with ASTM D737, including the endpoints. As described herein other desirable characteristics may impact air permeability. As such, one or more material layers or surfaces of the baffles 102 may be configured to exhibit air permeability measured in accordance with ASTM D737 of between 0.1 cfm and 3.0 cfm, between 0.1 cfm and 1.0 cfm, between 0.1 cfm and 2.0 cfm, between 1 cfm and 3.0 cfm, between 1 cfm and 2.0 cfm, including endpoints and intervening endpoints. A top or bottom layer or surface of one or more of the baffles 102 may have different material characteristics than those of the opposite top or bottom layer or surface of the same baffle 102.

The spacers 104 may be configured to have a higher air permeability that the baffles 102. The spacers 104 may be configured as breathability zones. The spacers 104 may be configured to exhibit air permeability measured in accordance with ASTM D737 of 3 cfm to 130 cfm, 3 cfm to 129 cfm, 3 cfm to 128 cfm, 3 cfm to 127 cfm, 3 cfm to 126 cfm, 3 cfm to 125 cfm, 3 cfm to 124 cfm, 3 cfm to 123 cfm, 3 cfm to 122 cfm, 3 cfm to 121 cfm, 3 cfm to 120 cfm, and intervening endpoints. The spacers 104 may be configured to exhibit air permeability measured in accordance with ASTM D737 of 3.4 cfm to 130 cfm, 3.4 cfm to 129 cfm, 3.4 cfm to 128 cfm, 3.4 cfm to 127 cfm, 3.4 cfm to 126 cfm, 3.4 cfm to 125 cfm, 3.4 cfm to 124 cfm, 3.4 cfm to 123 cfm, 3.4 cfm to 122 cfm, 3.4 cfm to 121 cfm, 3.4 cfm to 120 cfm, and intervening endpoints. The spacers 104 may be configured to exhibit air permeability measured in accordance with ASTM D737 of 3 cfm to 50 cfm, 3 cfm to 49 cfm, 3 cfm to 48 cfm, 3 cfm to 47 cfm, 3 cfm to 46 cfm, 3 cfm to 45 cfm, 3 cfm to 44 cfm, 3 cfm to 43 cfm, 3 cfm to 42 cfm, 3 cfm to 41 cfm, 3 cfm to 40 cfm, and intervening endpoints. The spacers 104 may be configured to exhibit air permeability measured in accordance with ASTM D737 of 3.4 cfm to 50 cfm, 3.4 cfm to 49 cfm, 3.4 cfm to 48 cfm, 3.4 cfm to 47 cfm, 3.4 cfm to 46 cfm, 3.4 cfm to 45 cfm, 3.4 cfm to 44 cfm, 3.4 cfm to 43 cfm, 3.4 cfm to 42 cfm, 3.4 cfm to 41 cfm, 3.4 cfm to 40 cfm, and intervening endpoints.

Example performance is illustrated in the below tables measured in accordance with ASTM D737:

| | | Connection |
|---|---|---|
| Air Permeability | Shell | Zone/spacer |
| Initial | 1.48 cfm | 42.0 (connection) |
| 3x Laundered | 1.30 cfm | |
| 10x Laundered | 1.29 cfm | |

Other materials and performances were achieved.

Reference to air permeability ranges may be applied to initial pre-wash materials. Reference to air permeability ranges may be applied to laundered materials. As an example, a single later spacer may exhibit the following example air permeability performance:

| | |
|---|---|
| Air Permeability | ASTM D737 |

| | |
|---|---|
| Initial | 122 cfm |
| 3x Laundered | 117 cfm |
| 10x Laundered | 108 cfm |

Other performance may be exhibited depending on the laundry cycles and underlying material layers.

As shown, the article may be or comprise a composite material. The composite material may comprise one or more of a face layer 106 or a lamination layer 108. A baffle layer may comprise a plurality of baffles 102 coupled to each other by material such as a spacer material (e.g., spacer 104) or base layer. Each of the baffles 102 may be configured as a two layer composite or material comprising a baffle face layer 202 and a baffle backside layer 204, such that the baffle face layer 202 and the baffle backside layer 204 define a cavity therebetween to receive an insulative material such as down or synthetic insulation. As an illustrative example, the face layer 202 is configured to be spaced from a wearer such the backside layer 204 is closer to the wearer than the face layer 202. Other configurations may be used. The lamination layer 108 may be disposed adjacent the baffle layer (e.g., on the upper layer). The face layer 106 may be disposed adjacent the lamination layer 108 such that the lamination layer 108 is interposed between the baffle layer and the face layer 106. Other configurations may be used. As an example, a face layer 106 may be included in the material stack without the lamination layer 108. Although reference is made to a “face” layer, a backer or backside layer may be used in a similar manner.

As an example, breathable areas (e.g., spacers 104) may be disposed between the baffles 102 in the baffle layer. Such breathable areas may comprise dissolvable yarns to increase air flow. Additionally or alternatively, bright yarns may be used to give a distinct appearance. The lamination layer 108 may be or comprise a film that may be disposed on the upper layer/surface of the baffle layer. As such, the upper layer/surface of the baffle layer may not need to contain or secure the down or other insulative material on its own. The lamination layer 108 or face layer 106 may act as a barrier for the down, and therefore that side of the baffle 102 textile does not have to have high density like the other side (lower layer/surface) of the baffle 102. By having an unbalanced warp, meaning more warp yarns get pushed to the side that needs it, one or more layers, surfaces, or sides may have fewer warp and/or weft yarns to lighten the textile, and to make it more breathable, as illustrated in FIG. 2. As illustrated in FIG. 2, where the baffle shell structures of the baffles 102 comprise a layer (e.g., back layer 204) with lower density yarns, a cover layer such as a the face layer 106 or lamination layer 108 or other layer (e.g., backer) may be disposed adjacent the baffle layer. Such configuration of warp and weft density may be applied to any layer or surface of the baffles 102, spacers 104, or other layers (e.g., face layer 106, lamination layer 108, or other layers).

Various materials may be used for any layer or surface of the baffles 102, spacers 104, or other layers 106, 108. As an example, a stretch material having elongation under pressure may be used. As a further example, a stretch material comprising elastomer may be used. As another example, a stretch material having 10-20% elastomer may be used.

### ASPECTS

The present disclosure includes at least the following aspects:

Aspect 1: A composite material for an insulation baffle, the composite material comprising: a baffle layer comprising a plurality of baffle shell structures coupled to one another by spacers, wherein each of the baffle shell structures comprises a baffle face layer and a baffle back layer that define a cavity therebetween, and wherein the spacers define a breathablity zone having a higher air permeability than one or more of the baffle face layer and the baffle back layer measured in accordance with ASTM D737; and a cover layer disposed on or adjacent the baffle back layer.

Aspect 2: The composite material of claim 1, wherein one or more of the spacers exhibits an air permeability of greater than 3 cfm measured in accordance with ASTM D737.

Aspect 3: The composite material of any one of claims 1-2, wherein one or more of the spacers exhibits an air permeability of greater than 3.4 cfm measured in accordance with ASTM D737.

Aspect 4: The composite material of any one of claims 1-3, wherein one or more of the spacers exhibits an air permeability of greater than 3 cfm to 120 cfm measured in accordance with ASTM D737.

Aspect 5: The composite material of any one of claims 1-4, wherein one or more of the spacers exhibits an air permeability of greater than 3.4 cfm to 50 cfm measured in accordance with ASTM D737.

Aspect 6: The composite material of any one of claims 1-5, wherein the baffle shell structures exhibits an air permeability of less than 3 cfm measured in accordance with ASTM D737.

Aspect 7: The composite material of any one of claims 1-6, wherein one or more of the baffle face layer and the baffle back layer for one or more of the baffle shell structures exhibits an air permeability of 0.1 cfm to 3 cfm measured in accordance with ASTM D737.

Aspect 8: The composite material of any one of claims 1-7, wherein one or more of the spacers are not down proof.

Aspect 9: The composite material of any one of claims 1-8, wherein one or more of the spacers comprise dissolvable yarn.

Aspect 10: The composite material of any one of claims 1-9, wherein the baffle face layer of one or more baffle shell structures is down proof.

Aspect 11: The composite material of any one of claims 1-10, wherein the baffle back layer of one or more baffle shell structures comprises less warp yarns relative to the baffle face layer of the same baffle shell structure.

Aspect 12: The composite material of any one of claims 1-11, wherein the baffle back layer of one or more baffle shell structures comprises less weft yarns relative to the baffle face layer of the same baffle shell structure.

Aspect 13: A method of making the composite material of any one of claims 1-12.

Aspect 14: An article comprising the composite material of any one of claims 1-13.

Aspect 15: The article of claim 14, wherein the article comprise a garment, a sleeping bag, or footwear.

Aspect 16: A composite material for a down-proof baffle, the composite material comprising: a baffle layer comprising a plurality of baffle structures coupled to one another by spacers, wherein each of the baffle structures comprises an upper layer and a lower layer that define a cavity therebetween; a lamination layer disposed on the upper layer of the one or more of the baffles; and a face layer disposed on or adjacent the upper layer such that the lamination layer is interposed between the face layer and the baffle layer.

Aspect 17: The composite material of claim 16, wherein one or more of the spacers exhibit a higher air permeability than the each of the baffle structures measured in accordance with ASTM D737.

Aspect 18: The composite material of any one of claims 16-17, wherein one or more of the upper layer and the lower layer of one or more of the baffle structures is down proof.

Aspect 19: The composite material of any one of claims 16-18, wherein one of the upper layer or the lower layer of one or more of the baffle structures comprises less warp yarns relative to the opposite one of the upper layer or the lower layer of the one or more of the baffle structures.

Aspect 20: The composite material of any one of claims 16-19, wherein one of the upper layer or the lower layer of one or more of the baffle structures comprises less weft yarns relative to the opposite one of the upper layer or the lower layer of the one or more of the baffle structures.

What is claimed is:

1. A composite material for an insulation baffle, the composite material comprising:
a baffle layer comprising a plurality of baffle shell structures coupled to one another by one or more spacers, wherein each of the baffle shell structures comprises a baffle face layer and a baffle back layer that define a cavity therebetween, and wherein the one or more spacers define a breathablity zone having a higher air permeability than one or more of the baffle face layer and the baffle back layer measured in accordance with ASTM D737; and
a cover layer disposed on or adjacent the baffle back layer.

2. The composite material of claim 1, wherein one or more of the spacers exhibits an air permeability of greater than 3 cfm measured in accordance with ASTM D737.

3. The composite material of claim 1, wherein one or more of the spacers exhibits an air permeability of greater than 3.4 cfm measured in accordance with ASTM D737.

4. The composite material of claim 1, wherein one or more of the spacers exhibits an air permeability of greater than 3 cfm to 120 cfm measured in accordance with ASTM D737.

5. The composite material of claim 1, wherein one or more of the spacers exhibits an air permeability of greater than 3.4 cfm to 50 cfm measured in accordance with ASTM D737.

6. The composite material of claim 1, wherein one or more of the plurality of baffle shell structures exhibits an air permeability of less than 3 cfm measured in accordance with ASTM D737.

7. The composite material of claim 1, wherein one or more of the baffle face layer and the baffle back layer of one or more of the plurality of baffle shell structures exhibits an air permeability of 0.1 cfm to 3 cfm measured in accordance with ASTM D737.

8. The composite material of claim 1, wherein one or more of the spacers are not down proof.

9. The composite material of claim 1, wherein one or more of the spacers comprise dissolvable yarn.

10. The composite material of claim 1, wherein the baffle face layer of one or more of the plurality of baffle shell structures is down proof.

11. The composite material of claim 1, wherein the baffle back layer of at least one of the plurality of baffle shell structures comprises less warp yarns relative to the baffle face layer of the at least one of the plurality of baffle shell structures.

12. The composite material of claim 1, wherein the baffle back layer of at least one of the plurality of baffle shell structures comprises less weft yarns relative to the baffle face layer of the at least one of the plurality of the baffle shell structures.

13. A method of making the composite material of claim 1.

14. An article comprising the composite material of claim 1.

15. The article of claim 14, wherein the article comprises a garment, a sleeping bag, or footwear.

16. A composite material for a down-proof baffle, the composite material comprising:
a baffle layer comprising a plurality of baffle structures coupled to one another by spacers, wherein each of the baffle structures comprises an upper layer and a lower layer that define a cavity therebetween;
a lamination layer disposed on the upper layer of the one or more of the baffle structures; and
a face layer disposed on or adjacent the upper layer such that the lamination layer is interposed between the face layer and the baffle layer.

17. The composite material of claim 16, wherein one or more of the spacers exhibit a higher air permeability than the each of the baffle structures measured in accordance with ASTM D737.

18. The composite material of claim 16, wherein one or more of the upper layer and the lower layer of one or more of the baffle structures is down proof.

19. The composite material of claim 16, wherein one of the upper layer or the lower layer of one or more of the baffle structures comprises less warp yarns relative to the opposite one of the upper layer or the lower layer of the one or more of the baffle structures.

20. The composite material of claim 16, wherein one of the upper layer or the lower layer of one or more of the baffle structures comprises less weft yarns relative to the opposite one of the upper layer or the lower layer of the one or more of the baffle structures.
